(19) United States
(12) Patent Application Publication
(10) Pub. No.: US 2011/0055157 A1
(43) Pub. Date: Mar. 3, 2011

(54) SYSTEM, APPARATUS, AND METHOD WITH AUTOMATIC FILE COPYING FUNCTION

(75) Inventor: XU-XING YAN, Shenzhen City (CN)

(73) Assignees: HONG FU JIN PRECISION INDUSTRY (ShenZhen) CO., LTD., ShenZhen City (CN); HON HAI PRECISION INDUSTRY CO., LTD., Tu-Cheng (TW)

(21) Appl. No.: 12/606,193

(22) Filed: Oct. 27, 2009

(30) Foreign Application Priority Data
Aug. 31, 2009 (CN) 200910306346.3

(51) Int. Cl. G06F 12/16; G06F 12/00

(52) U.S. Cl. 707/626; 707/E17.01; 711/E12.001; 711/E12.103; 707/621

(57) ABSTRACT

An electronic apparatus with an automatic file copying function is provided. The electronic apparatus comprises a processing unit and a data storage. When detecting a mobile data storage is connected to the electronic apparatus, the processing unit detects whether there are files with a predetermined marking in the mobile data storage, and copies the files with the predetermined marking in the mobile data storage to the data storage if there are files with the predetermined marking in the mobile data storage.

### BACKGROUND

1. Technical Field

The present disclosure relates to a system, an apparatus, and a method with a function for automatically copying file.

2. Description of Related Art

Generally, when a mobile data storage, such as a flash memory disk or a SD card, is used to copy files from a first electronic apparatus to a second electronic apparatus, the files need to be copied from the first electronic apparatus to the mobile data storage firstly, and then copied from the mobile data storage to the second electronic apparatus. But when files are copied from the mobile data storage to the second electronic apparatus, the user must select the files that need to be copied to the second electronic apparatus in the mobile data storage firstly, and then copy them manually to the second apparatus, which is inefficient and inconvenient for users.

### BRIEF DESCRIPTION OF THE DRAWINGS

The components of the drawings are not necessarily drawn to scale, the emphasis instead being placed upon clearly illustrating the principles of a system, an apparatus, and a method with an automatic file copying function. Moreover, in the drawings, like reference numerals designate corresponding parts throughout several views.

FIG. 1 is a block diagram of a system with an automatic file copying function in accordance with an exemplary embodiment.

FIG. 2 is a flow chart of an automatic file copying method in accordance with an exemplary embodiment.

### DETAILED DESCRIPTION

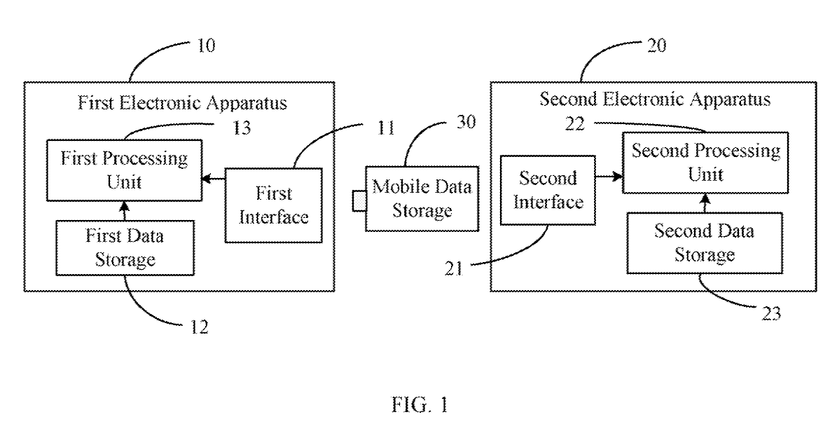

FIG. 1 is a block diagram of a system 1 with an automatic file copying function (hereinafter “the system”) in accordance with an exemplary embodiment. The system includes a first electronic apparatus 10, a second electronic apparatus 20, and a mobile data storage 30. The first electronic apparatus 10 is for marking files selected by user and copying the marked files to the mobile data storage 30. The second electronic apparatus 20 can automatically retrieve copies of the marked files from the mobile data storage 30.

The first electronic apparatus 10 includes a first interface 11, a first data storage 12, and a first processing unit 13. The first data storage 12 is for storing the files of the first electronic apparatus 10. The first interface 11 is for connecting to the mobile data storage 30. After detecting that the mobile data storage 30 is connected to the first electronic apparatus 10, the first processing unit 13 responds to selection operations of the user to select files to copy and responds to marking operations of the user to mark the selected files with a predetermined marking. The predetermined marking can be a special character string or an extension added in the name of each file. The marked files are copied to the mobile data storage 30.

The second electronic apparatus 20 includes a second interface 21, a second processing unit 22, and a second data storage 23. The second interface 21 is for connecting the mobile data storage 30. When detecting the mobile data storage 30 is connected to the second electronic apparatus 20, the second processing unit 22 detects whether there are files with the predetermined markings in the mobile data storage 30. If there are files with the predetermined marking in the mobile data storage 30, the second processing unit 22 automatically copies the files with the predetermined marking in the mobile data storage 30 to the second data storage 23.

During or after the process of copying the files with the predetermined marking to the second data storage 23, the second processing unit 22 classifies the files according to suffixes of the files and stores the classified files to a corresponding file folder. For example, a file with suffix “.doc” is classified as WORD file, and is stored to a folder for WORD documents in the second data storage 23, the file with suffix “.jpg” is classified as image file, and is stored to an image file folder in the second data storage 23.

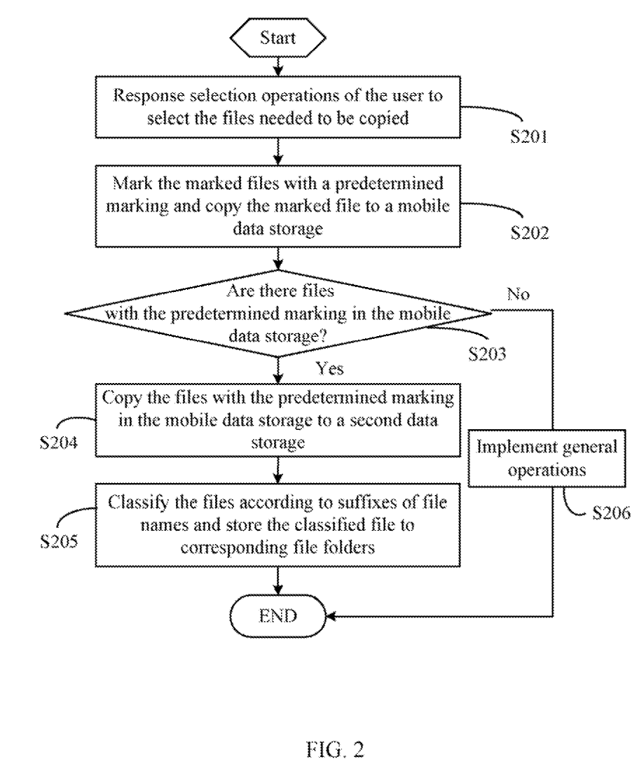

FIG. 2 is a flow chart of an automatic file copying method in accordance with an exemplary embodiment.

In step S201, after detecting that the mobile data storage 30 is connected to the first electronic apparatus 10, the first processing unit 13 responds to selection operations of the user to select the files to copy.

In step S202, the first processing unit 13 responds to marking operations of the user to mark the selected files with a predetermined marking and copies the marked files to the mobile data storage 30.

In step S203, after detecting the mobile data storage 30 is connected to the second electronic apparatus 20, the second processing unit 22 detects whether there are files with the predetermined marking in the mobile data storage 30.

In step S204, if there are files with the predetermined marking in the mobile data storage 30, the second processing unit 22 automatically copies the files with the predetermined marking in the mobile data storage 30 to the second data storage 23.

In step S205, during or after the process of copying the files with predetermined marking to the second data storage 23, the second processing unit 22 classify the files according to the suffixes of the file names and stores the classified files to the corresponding file folders.

In step S206, if there are not files with the predetermined marking in the mobile data storage 30 in step S204, the second processing unit 22 implements general operations.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic apparatus with an automatic file copying function, comprising a processing unit and a data storage, wherein when detecting a mobile data storage is connected to the electronic apparatus, the processing unit detects whether there are files with a predetermined marking in the mobile data storage, and copies the files with the predetermined marking in the mobile data storage to the data storage if there are files with the predetermined marking in the mobile data storage.

2. The electronic apparatus as described in claim 1, wherein during or after the process of copying the files with predetermined marking to the data storage, the processing unit classifies the files according to suffixes of the file names and stores the classified files to a corresponding file folder.

3. The electronic apparatus as described in claim 1, wherein the predetermined marking is a special character string or an extension added in a name of each file.

4. An automatic file copying system, comprising a first electronic apparatus, a second electronic apparatus and a mobile data storage, the first electronic apparatus comprising a first processing unit and a first data storage, the second electronic apparatus comprising a second processing unit and a second data storage, when detecting that the mobile data storage is connected to the first electronic apparatus, the first processing unit responding to selection operations of the user to select files to copy and responding to marking operations of the user to mark the selected files with a predetermined marking, when detecting the mobile data storage is connected to the second electronic apparatus, the second processing unit detecting whether there are files with the predetermined marking in the mobile data storage, if there are files with the predetermined marking in the mobile data storage, the second processing unit automatically copying the files with the predetermined marking in the mobile data storage to the second data storage.

5. The system as described in claim 4, wherein during or after the process of copying the files with predetermined marking to the second data storage, the second processing unit classifies the files according to suffixes of the file names and stores the classified files to a corresponding file folder.

6. The system as described in claim 4, wherein the predetermined marking is a special character string or an extension added in a name of each file.

7. An automatic file copying method, the method being implemented by a first electronic apparatus, a second electronic apparatus, comprising:
when detecting that the mobile data storage is connected to the first electronic apparatus, the first electronic apparatus responding to selection operations of the user to select files to copy and responding to marking operations of the user to mark the selected files with a predetermined marking;
when detecting the mobile data storage is connected to the second electronic apparatus, the second electronic apparatus detecting whether there are files with the predetermined markings in the mobile data storage, if there are files with the predetermined marking in the mobile data storage, the second electronic apparatus automatically copying the files with the predetermined marking in the mobile data storage to the second electronic apparatus.

8. The method as described in claim 7, further comprising: during or after the process of copying the files with predetermined marking to the second data storage, the second electronic apparatus classifying the files according to suffixes of the file names and storing the classified files to a corresponding file folder.

9. The method as described in claim 7, wherein the predetermined marking is a special character string or an extension added in a name of each file.
